(19) United States
(12) Patent Application Publication
(10) Pub. No.: US 2013/0022850 A1
(43) Pub. Date: Jan. 24, 2013

(54) ELECTRONIC DEVICE

(71) Applicant: Ju-Ling Chuang, Hsinchu County (TW)

(72) Inventor: Ju-Ling Chuang, Hsinchu County (TW)

(73) Assignee: ALTEK CORPORATION, Hsinchu City (TW)

(21) Appl. No.: 13/216,274

(22) Filed: Aug. 24, 2011

(30) Foreign Application Priority Data
Jul. 21, 2011 (TW) 100125802

(51) Int. Cl. H01M 2/10

(52) U.S. Cl. 429/100

(57) ABSTRACT

An electronic device including a body, a battery, a cover, and a fixing member is provided. The body has a receiving trough. The battery moves in or out of the receiving trough along a moving axis. The cover is movably assembled to the body and moves between an opening position and a closing position relative to the receiving trough. The fixing member is disposed on the cover. While the cover moves from the opening position to the closing position, the cover pushes the battery into the receiving trough through the fixing member. When the cover is at the closing position, the fixing member leans against the battery along the moving axis to fix the battery within the receiving trough.

### CROSS-REFERENCE TO RELATED APPLICATION

This application claims the priority benefit of Taiwan application serial no. 100125802, filed on Jul. 21, 2011. The entirety of the above-mentioned patent application is hereby incorporated by reference herein and made a part of this specification.

### BACKGROUND OF THE INVENTION

1. Field of the Invention

The invention generally relates to an electronic device, and more particularly, to an electronic device with a battery fixing structure.

2. Description of Related Art

Human's life has been made very convenient along with the development of technologies. In today's information age, 3C electronic products have become one of the most indispensable products in our daily life. In order to make 3C electronic products portable and convenient to use, batteries are usually installed in 3C electronic products. For example, a battery is placed into a battery chamber of a 3C electronic product and configured to supply power to the 3C electronic product.

Taking a digital camera as an example, in order to allow a user to use the digital camera conveniently, a battery is used for supplying power required by the operation of the digital camera. Thus, a receiving trough is formed inside the body of the digital camera for containing the battery, and a cover is assembled onto the body so that the receiving trough can be covered or the battery can be taken out of the receiving trough to be replaced through the movement of the cover relative to the body. Additionally, in order to prevent the battery from running around inside the receiving trough (which may cause loose contact), a fastening structure is further disposed inside the receiving trough. After being placed into the receiving trough, the battery is fastened by the fastening structure so that the electrical connection between the battery and the body is secured. However, this technique increases both the number of components and the manufacturing cost of the digital camera. Thereby, how to fix a battery inside a receiving trough of a 3C electronic product without increasing the number of components and the manufacturing cost of the 3C electronic product has become one of the major subjects in the industry.

### SUMMARY OF THE INVENTION

Accordingly, the invention is directed to an electronic device with a simplified battery fixing structure.

According to an embodiment of the invention, an electronic device including a body, a battery, a cover, and a fixing member is provided. The body has a receiving trough. The battery moves in or out of the receiving trough along a moving axis. The cover is movably assembled to the body. The cover moves between an opening position and a closing position relative to the receiving trough. The fixing member is disposed on the cover. While the cover moves from the opening position to the closing position, the cover pushes the battery into the receiving trough through the fixing member. When the cover is at the closing position, the fixing member leans against the battery along the moving axis to fix the battery within the receiving trough.

According to an embodiment of the invention, the battery has a plurality of first terminals and a connecting surface and a leaning surface that are opposite to each other. The first terminals are located on the connecting surface. When the cover is at the closing position, the fixing member leans against the leaning surface.

According to an embodiment of the invention, the leaning surface and the connecting surface are respectively perpendicular to the moving axis.

According to an embodiment of the invention, the electronic device further includes a plurality of second terminals, wherein the second terminals are disposed in the receiving trough and are respectively corresponding to the first terminals. When the cover is at the closing position, the first terminals lean against and are electrically connected with the second terminals.

According to an embodiment of the invention, when the cover is at the opening position, the second terminals push the battery away from the receiving trough along the moving axis.

According to an embodiment of the invention, the fixing member and the cover are formed in an integral structure.

According to an embodiment of the invention, the fixing member has a chamfer. The leaning surface of the battery is on the moving path of the chamfer while the cover moves from the opening position to the closing position.

According to an embodiment of the invention, the body has a track located on the top of the receiving trough, and the cover has a movable portion coupled to the track. The movable portion moves along the track to slide or rotate the cover relative to the body.

According to an embodiment of the invention, the track has a pair of positioning portions opposite to each other. The movable portion respectively interferes with the positioning portions to position the cover at the opening position or the closing position.

According to an embodiment of the invention, the track further has a blocking portion. The blocking portion is clipped onto the cover along a direction perpendicular to the moving axis to locate the cover at the opening position.

As described above, in an electronic device provided by an embodiment of the invention, a cover is movably assembled to a body and a fixing member is disposed on the cover, so that the cover pushes a battery into the receiving trough of the body through the fixing member while the cover moves from a opening position to a closing position relative to a receiving trough of the body, and after the cover reaches the closing position, the fixing member on the cover leans against the battery along a moving axis of the battery to fix the battery within the receiving trough. Thus, no fastening structure for fixing the battery needs to be disposed in the electronic device, and accordingly the number of components and the manufacturing cost of the electronic device are both reduced.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an assembly diagram of an electronic device according to an embodiment of the invention.

FIG. 2A and FIG. 2B are respectively partial views of the electronic device in FIG. 1 when a battery is installed.

FIG. 3A and FIG. 3B are diagrams illustrating how a cover moves relative to a body in an electronic device according to another embodiment of the invention.

FIG. 3C and FIG. 3D are enlarged partial views respectively corresponding to FIG. 3A and FIG. 3B.

FIGS. 4A-4D are diagrams illustrating how a cover moves relative to a body in an electronic device according to another embodiment of the invention.

FIG. 4E is a cross-sectional enlarged partial view of the electronic device in FIG. 4D.

FIG. 5A is an enlarged partial view of a cover of an electronic device according to another embodiment of the invention.

FIG. 5B is a diagram of the electronic device in FIG. 5A at another viewing angle.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

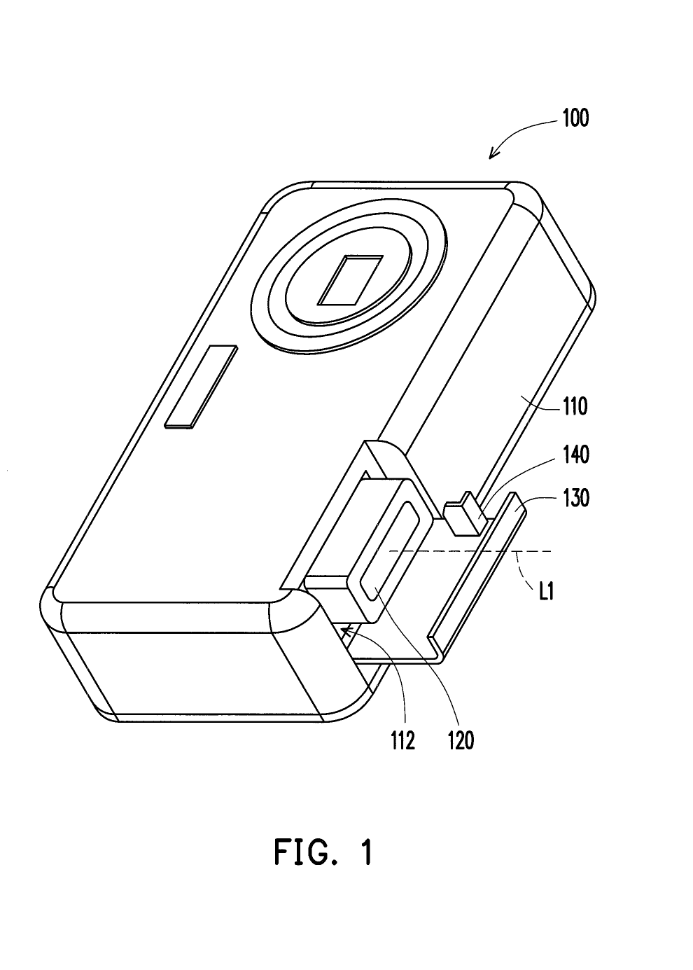

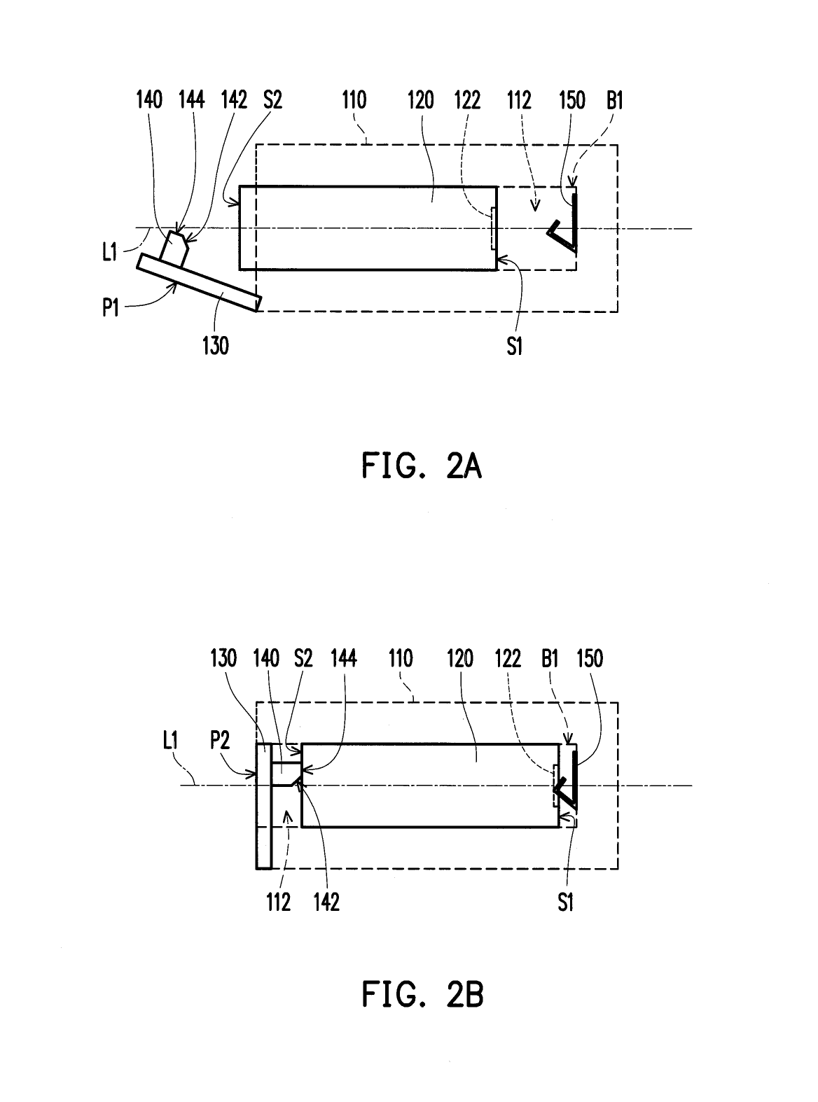

FIG. 1 is an assembly diagram of an electronic device according to an embodiment of the invention. FIG. 2A and FIG. 2B are respectively partial views of the electronic device in FIG. 1 when a battery is installed. Referring to FIG. 1, FIG. 2A, and FIG. 2B, in the present embodiment, the electronic device 100 may be a digital camera, and which includes a body 110, a battery 120, a cover 130, and a fixing member 140. The body 110 has a receiving trough 112. The battery 120 may be a lithium battery, and which moves in or out of the receiving trough 112 along a moving axis L1. The cover 130 is movably assembled to the body 110 and moves between an opening position P1 and a closing position P2 relative to the receiving trough 112. The fixing member 140 is disposed on the cover 130. When the cover 130 moves from the opening position P1 to the closing position P2, the cover 130 pushes the battery 120 into the receiving trough 112 through the fixing member 140. Besides, when the cover 130 is at the closing position P2 (i.e., the cover 130 completely covers the receiving trough 112), the fixing member 140 leans against the battery 120 along the moving axis L1 to fix the battery 120 within the receiving trough 112.

As described above, in the electronic device 100, the cover 130 pushes the battery 120 into the receiving trough 112 through the fixing member 140 disposed on the cover 130, and when the cover 130 is assembled to the body 110 and completely covers the receiving trough 112, the fixing member 140 fixes the battery 120 within the receiving trough 112 along the moving axis L1. Compared to the conventional technique in which a fastening structure for fixing the battery is further disposed in the receiving trough, the electronic device 100 in the invention requires fewer components and lower manufacturing cost.

To be specific, referring to FIG. 2A and FIG. 2B, the battery 120 has a first terminal 122 and a connecting surface S1 and a leaning surface S2 that are opposite to each other, wherein the first terminal 122 is on the connecting surface S1. The electronic device 100 further includes a second terminal 150. The second terminal 150 is disposed in the receiving trough 112 and is corresponding to the first terminal 122 of the battery 120. In the present embodiment, the leaning surface S2 and the connecting surface S1 of the battery 120 are respectively perpendicular to the moving axis L1. Accordingly, when the cover 130 is at the closing position P2, the fixing member 140 leans against the leaning surface S2 so that the connecting surface S1 of the battery 120 leans against the bottom B1 of the receiving trough 112 and the battery 120 is fixed. Meanwhile, the first terminal 122 on the connecting surface S1 also leans against the second terminal 150 so that the first terminal 122 and the second terminal 150 are electrically connected with each other and accordingly the battery 120 can supply power to the body 110.

The second terminal 150 is substantially a metal dome. Thus, when the first terminal 122 of the battery 120 leans against the second terminal 150, it compresses the second terminal 150, so that when the cover 130 moves from the closing position P2 to the opening position P1 (i.e., the cover 130 is disassembled from the body 110), the battery 120 loses the support of the fixing member 140 and the elasticity of the second terminal 150 pushes the battery 120 away from the receiving trough 112 along the moving axis L1. In this case, a user can replace the battery 120 conveniently. The cover 130 and the fixing member 140 may be fabricated integrally by using plastic to reduce both the number of components and the manufacturing cost. However, the material of the cover 130 and the fixing member 140 is not limited herein.

In addition, it should be mentioned that the fixing member 140 may be a protruding structure located on the internal surface of the cover 130, and the protruding structure faces the receiving trough 112 when the cover 130 moves between the opening position P1 and the closing position P2. Besides, the fixing member 140 has a chamfer 142 located on the top of the fixing member 140. When the cover 130 moves from the opening position P1 to the closing position P2 relative to the body 110, the leaning surface S2 of the battery 120 is substantially located on the moving path of the chamfer 142. In other words, when the cover 130 is at the closing position P2, the chamfer 142 is substantially a slanted surface opposite to the leaning surface S2. Accordingly, when the cover 130 moves towards the closing position P2, the chamfer 142 first leans against the battery 120, so that a user can push the battery 120 into the receiving trough 112 through the cover 130. After the cover 130 reaches the closing position P2, the fixing member 140 leans against the leaning surface S2 with a surface 144 parallel to the leaning surface S2 (and the surface 144 and the chamfer 142 are adjoining surfaces which form an acute angle). Thus, the existence of the chamfer 142 prevents any interference between the fixing member 140 and the battery 120 and allows the cover 130 and the battery 120 to move smoothly.

The moving mechanism of the cover 130 relative to the body 110 is not limited in the invention. Namely, it is within the scope of the invention as long as the battery 120 can be fixed within the receiving trough 112 through the relative movement between the cover 130 and the body 110. Below, the moving mechanism between the cover and the body will be explained with reference to a few embodiments.

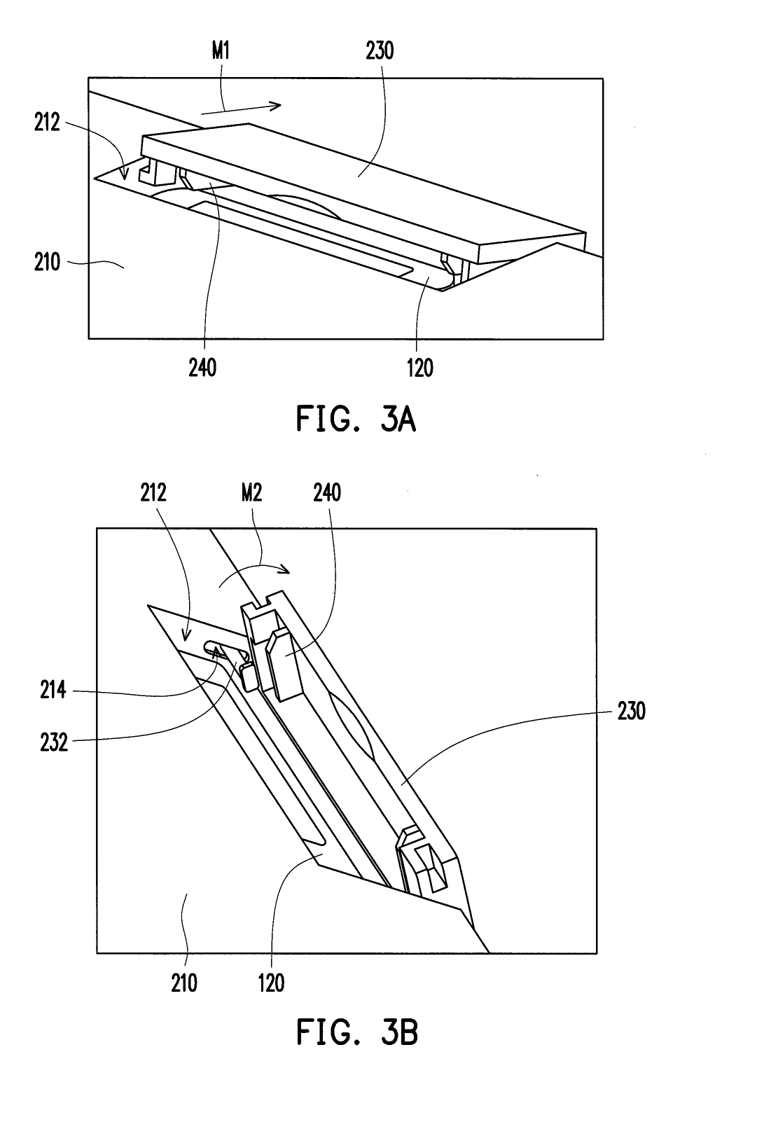

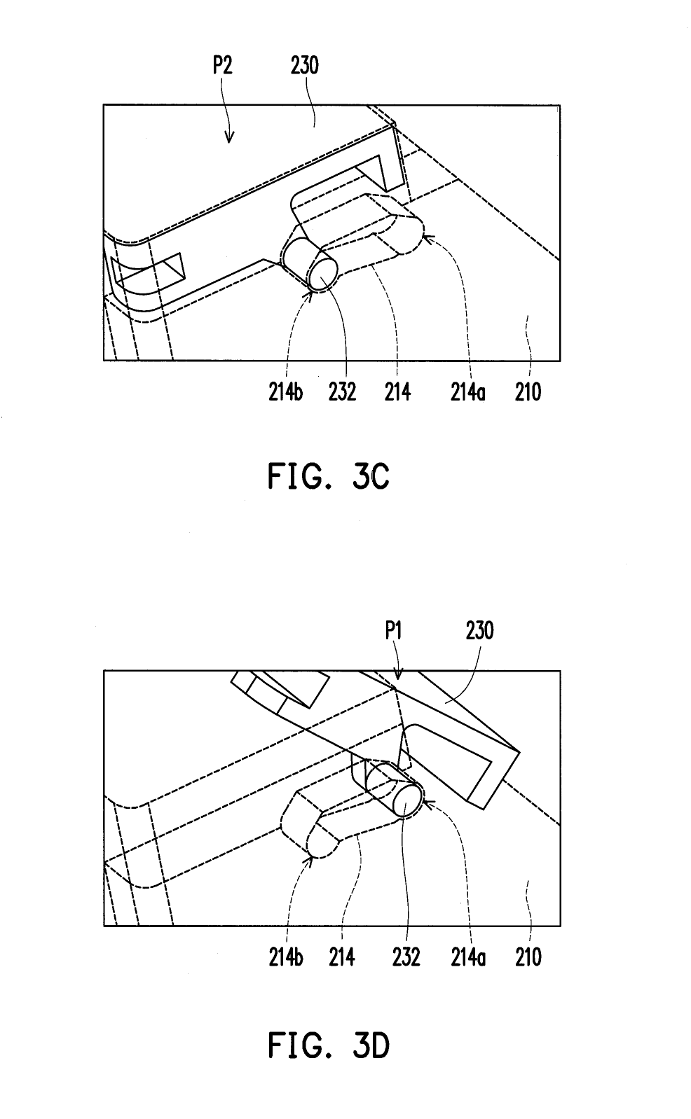

FIG. 3A and FIG. 3B are diagrams illustrating how a cover moves relative to a body in an electronic device according to another embodiment of the invention. FIG. 3C and FIG. 3D are enlarged partial views respectively corresponding to FIG. 3A and FIG. 3B. Referring to FIGS. 3A-3D, in the present embodiment, the body 210 has a track 214 located on the tope of the receiving trough 212, and the cover 230 has a movable portion 232 coupled to the track 214. The cover 230 is slid or rotated relative to the body 210 when the movable portion 232 moves along the track 214. When the cover 230 moves from the opening position P1 to the closing position P2, the fixing member 240 disposed on the cover 230 pushes the battery 120 into the receiving trough 212 and fixes the battery 120 within the receiving trough 212.

In addition, the track 214 has a pair of positioning portions 214a and 214b opposite to each other. When the movable portion 232 moves to the positioning portions 214a and 214b, the cover 230 is positioned at the opening position P1 and the closing position P2. For example, to open the receiving trough 212, the cover 230 first slides relative to the body 210 along a first path M1 from the closing position P2 (as shown in FIG. 3C). Namely, the movable portion 232 moves from the positioning portion 214b to the positioning portion 214a. After the movable portion 232 reaches the positioning portion 214a, it drives the cover 230 to rotate relative to the body 210 along a second path M2 until the cover 230 reaches the opening position P1.

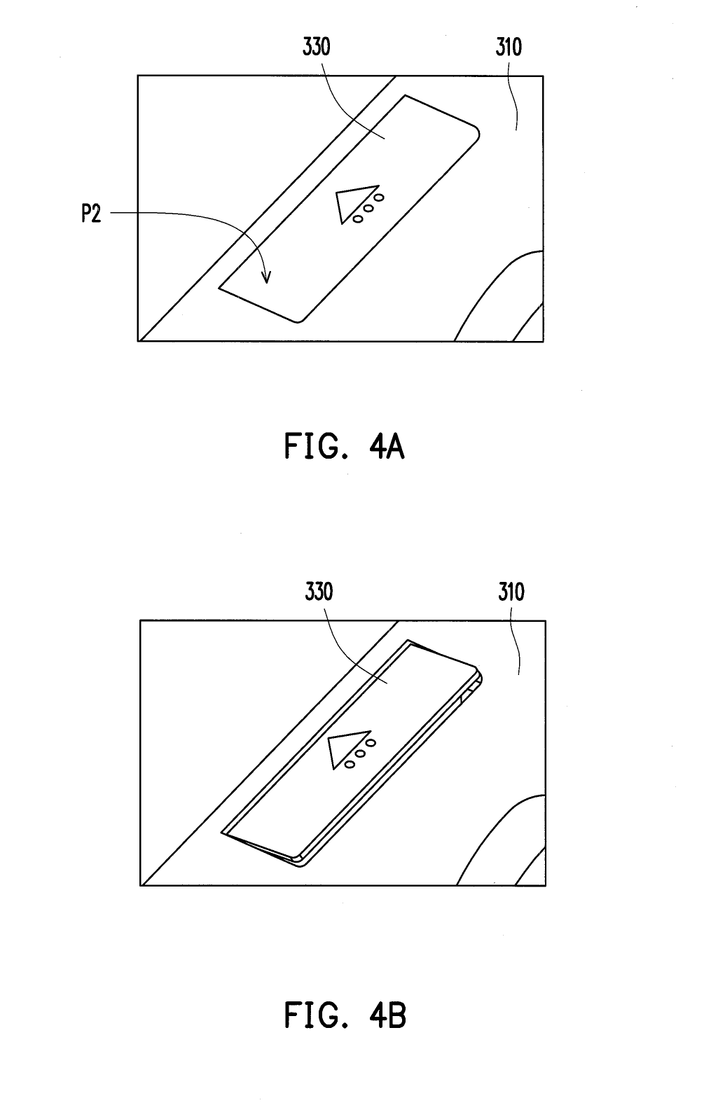

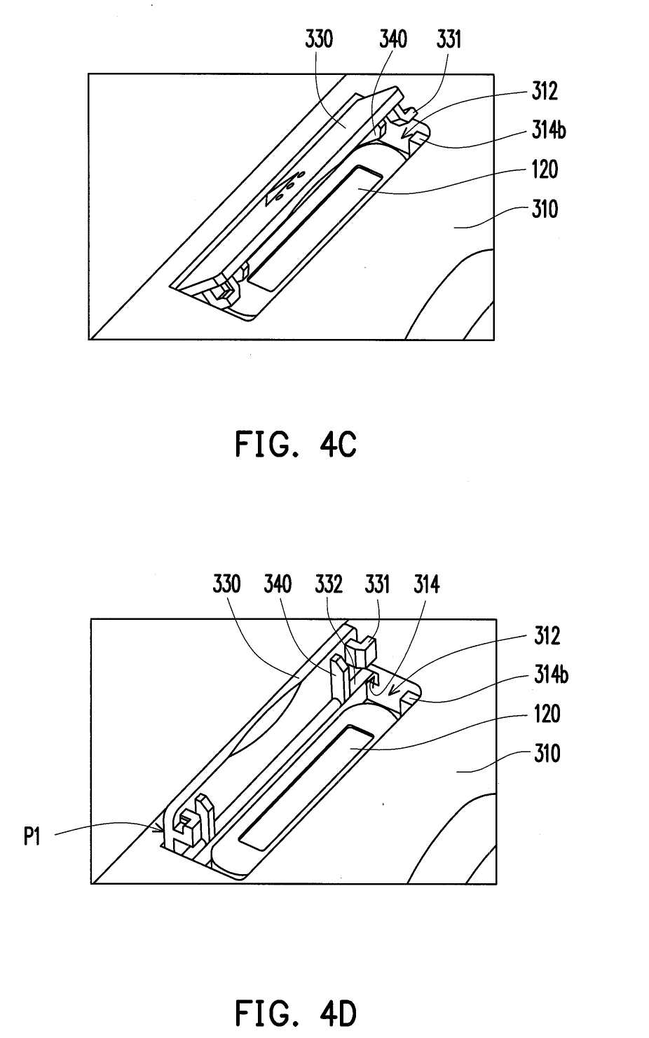

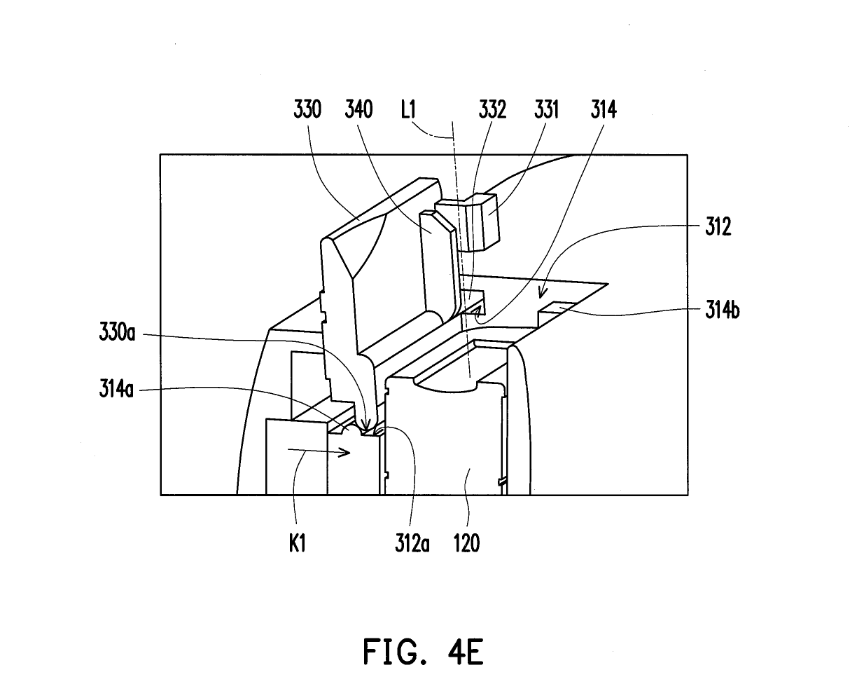

FIGS. 4A-4D are diagrams illustrating how a cover moves relative to a body in an electronic device according to another embodiment of the invention. FIG. 4E is a cross-sectional enlarged partial view of the electronic device in FIG. 4D. Referring to FIGS. 4A-4E, in the present embodiment, when the movable portion 332 of the cover 330 slides and rotates relative to the body 310 along the track 314, the cover 330 moves from the closing position P2 to the opening position P1 and accordingly the fixing member 340 disposed on the cover 330 pushes the battery 120 into the receiving trough 312 and fixes the battery 120 within the receiving trough 312.

Referring to FIG. 4E again, unlike that in foregoing embodiment, the body 310 further has a pair of positioning portions 314a and 314b. When the cover 330 is at the opening position P1, the positioning portion 314a is snapped onto the cover 330 along a snap direction K1 perpendicular to the moving axis L1 and accordingly positions the cover 330 at the opening position P1. In the present embodiment, the positioning portion 314a may be a protrusion located on a step 312a on the top of the receiving trough 312, and which is snapped to the periphery 330a of the cover 330 to position the cover 330 at the opening position P1. In addition, the positioning portion 314b may be a rib protruding from the sidewall of the receiving trough 312, and the cover 330 further has a snap portion 331 corresponding to the rib. When the cover 330 is at the closing position P2, the positioning portion 314b is snapped with the snap portion 331 so that the cover 330 can completely cover the receiving trough 312.

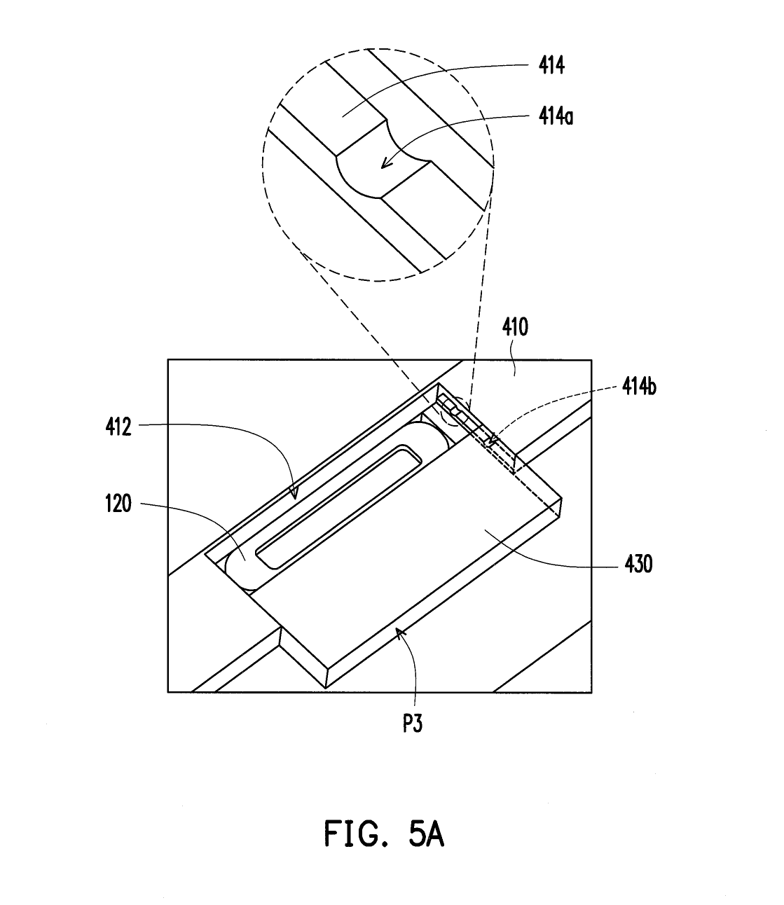

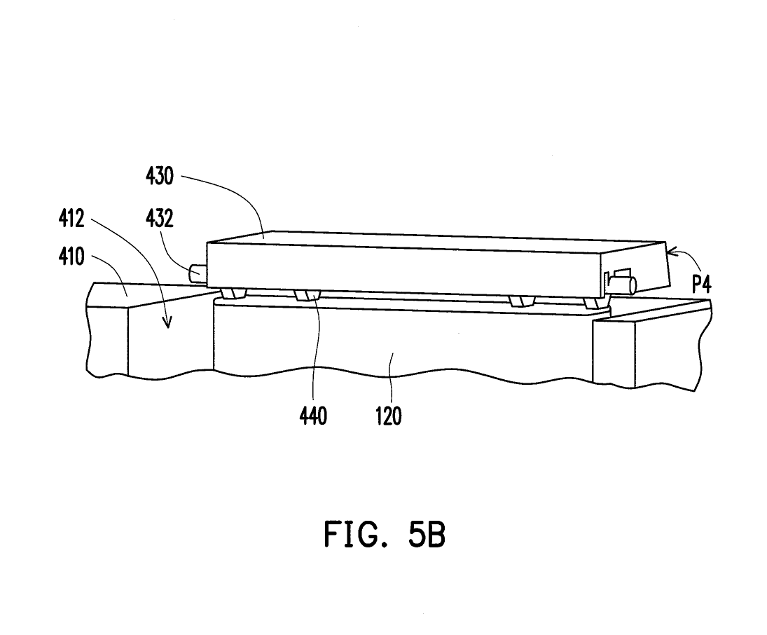

FIG. 5A is an enlarged partial view of a cover of an electronic device according to another embodiment of the invention, in which the movement of the cover relative to the body is illustrated. FIG. 5B is a diagram of the electronic device in FIG. 5A at another viewing angle, in which part of the body is omitted in order to show the relation between the cover and the battery clearly. Referring to both FIG. 5A and FIG. 5B, in the present embodiment, the movable portion 432 of the cover 430 slides on the track 414 of the body 410 back and forth, so as to allow the cover 430 to alternate between the opening position P3 and the closing position P4 relative to the body 410. When the cover 430 moves to the closing position P4, the battery 120 is pushed into and fixed within the receiving trough 412 by the fixing member 440 disposed on the cover 430. Additionally, unlike that in foregoing embodiment, the track 414 has a pair of positioning portions 414a and 414b opposite to each other. The positioning portions 414a and 414b may be depressions on the track 414, and the movable portion 432 may be a roller extended from both sides of the cover 430. The movable portion 432 respectively interferes with the positioning portions 414a and 414b to position the cover 430 at the opening position P3 and the closing position P4, so that a good operation feeling can be achieved when a user operates the cover 430.

As described above, in an electronic device provided by an embodiment of the invention, a cover is movably assembled to a body and a fixing member is disposed on the cover, so that the cover pushes a battery into the receiving trough of the body through the fixing member while the cover moves from a opening position to a closing position relative to a receiving trough of the body, and after the cover reaches the closing position, the fixing member on the cover leans against the battery along a moving axis of the battery to fix the battery within the receiving trough. Thus, no fastening structure for fixing the battery needs to be disposed in the electronic device, and accordingly the number of components and the manufacturing cost of the electronic device are both reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electronic device, comprising:
a body, having a receiving trough;
a battery, moving in or out of the receiving trough along a moving axis;
a cover, movably assembled to the body, moving between an opening position and a closing position relative to the receiving trough; and
a fixing member, disposed on the cover, wherein while the cover moves from the opening position to the closing position, the cover pushes the battery into the receiving trough through the fixing member, and when the cover is at the closing position, the fixing member leans against the battery along the moving axis to fix the battery within the receiving trough.

2. The electronic device according to claim 1, wherein the battery has a plurality of first terminals, and a connecting surface and a leaning surface that are opposite to each other, the first terminals are located on the connecting surface, and when the cover is at the closing position, the fixing member leans against the leaning surface.

3. The electronic device according to claim 2, wherein the leaning surface and the connecting surface are respectively perpendicular to the moving axis.

4. The electronic device according to claim 2 further comprising:
a plurality of second terminals, disposed in the receiving trough and respectively corresponding to the first terminals, wherein when the cover is at the closing position, the first terminals lean against and are electrically connected with the second terminals.

5. The electronic device according to claim 4, wherein when the cover is at the opening position, the second terminals pushes the battery away from the receiving trough along the moving axis.

6. The electronic device according to claim 2, wherein the fixing member and the cover are formed in an integral structure.

7. The electronic device according to claim 6, wherein the fixing member has a chamfer, and the leaning surface of the battery is on a moving path of the chamfer while the cover moves from the opening position to the closing position.

8. The electronic device according to claim 1, wherein the body has a track located on a top of the receiving trough, the cover has a movable portion coupled to the track, and the movable portion moves along the track to slide or rotate the cover relative to the body.

9. The electronic device according to claim 8, wherein the track has a pair of positioning portions opposite to each other, and the movable portion respectively interferes with the positioning portions to position the cover at the opening position or the closing position.

10. The electronic device according to claim 9, wherein at least one of the positioning portions is clipped onto the cover along a direction perpendicular to the moving axis to locate the cover at the opening position.
